(19) United States
(12) Patent Application Publication
(10) Pub. No.: US 2026/0324910 A1
(43) Pub. Date: Oct. 22, 2026

(54) CHAIR-ATTACHABLE BATHING DEVICE

(71) Applicant: Hydrocare Technologies LLC, Buford, GA (US)

(72) Inventor: Banks Bitterman, Buford, GA (US)

(73) Assignee: Hydrocare Technologies LLC, Buford, GA (US)

(21) Appl. No.: 19/695,385

(22) Filed: Jun. 2, 2026

Related U.S. Application Data
(63) Continuation of application No. PCT/US2025/020381, filed on Mar. 18, 2025.
(60) Provisional application No. 63/573,670, filed on Apr. 3, 2024.

(51) Int. Cl. A47K 3/28; A01K 13/00; A61H 9/00; A61H 19/00; B05B 1/16; E03C 1/04

(52) U.S. Cl. CPC A47K 3/282; A01K 13/001; A61H 9/0021; A61H 19/30; B05B 1/16; E03C 1/0403; E03C 1/0408

(57) ABSTRACT

A furniture-attachable bathing device addresses hygiene, intimate wellness, and animal care needs for individuals with physical limitations. The device features upward-facing water jets paired with drainage openings having collective volume capacity equal to or exceeding jet output, preventing water accumulation that would inhibit upward spray pressure. Water jet outlet diameters are sized to distribute pressure over sufficient surface area to prevent pain during high-pressure operation. Selective jet activation enables pressure concentration in desired areas. A diamond-pattern water supply and drainage system optimizes water distribution. Applications include intimate area cleaning, therapeutic genital stimulation enabling independent sexual wellness, and washing small companion animals. Ergonomic pressure controls accommodate users with limited manual dexterity.

### CROSS REFERENCE TO RELATED APPLICATIONS

This application claims priority to and the benefit of PCT Patent Application PCT/US 25/20381 filed on Mar. 18, 2025, and United States Provisional Patent Application 63/573,670 filed on Apr. 3, 2024, each of which is hereby incorporated by reference in its entirety.

### BACKGROUND OF THE INVENTION

Personal hygiene and bathing presents significant daily challenges for individuals with physical limitations, those recovering from surgery, and those needing additional assistance who may be unable to use traditional bathing methods. Many people, particularly elderly and disabled individuals, face difficulties maintaining proper hygiene independently, which often requires intervention from caretakers. Traditional bathing solutions like bathtubs and showers pose serious safety risks, particularly for elderly persons, and are a leading cause of slip and fall injuries. These challenges extend beyond personal care to impact other aspects of daily living that require similar physical capabilities, such as the ability to properly bathe and care for companion animals, which can be particularly challenging for those with limited mobility or physical restrictions. Additionally, individuals with physical limitations or disabilities may face barriers to maintaining intimate personal care and experiencing physical satisfaction independently, further impacting their quality of life and personal autonomy. Current methods typically require either complete reliance on caretakers or risking injury through traditional bathing facilities, creating significant gaps in available solutions for independent personal care across multiple aspects of daily living.

For elderly individuals specifically, the inability to properly clean themselves after urinating or defecating creates a situation where they become dependent on others for these intimate care needs. This loss of independence in such a personal matter can be particularly distressing for the affected individuals. The disabled population faces similar challenges, where physical limitations may prevent them from performing adequate cleansing routines. These limitations can be temporary, such as during recovery from surgery, or permanent conditions that affect their mobility or dexterity.

Traditional cleansing methods present numerous limitations and challenges for both individuals requiring care and their caretakers. The primary method involves the manual process of removing a diaper and using disposable wipes for cleaning, which can be both inefficient and uncomfortable for all parties involved.

This conventional approach requires direct hands-on assistance from caretakers, who must undertake the unenviable task of manually cleansing individuals after urination or defecation. The process is particularly challenging when dealing with elderly or disabled individuals who cannot participate in their own hygiene care.

The alternative traditional method involves using a bathtub or shower for cleansing. However, this approach presents its own set of significant problems. Most notably, it creates a serious safety hazard, as it is a leading cause of slip and fall injuries, particularly among elderly individuals. This risk exists whether the person is attempting to clean themselves independently or receiving assistance from a caretaker.

For individuals recovering from surgery or those with physical limitations, these traditional cleaning methods can be especially problematic. The physical movements required for effective cleaning using conventional methods may be difficult or impossible for those with limited mobility or dexterity, further complicating the cleaning process.

The inadequacy of these traditional methods highlights a significant gap in personal hygiene solutions, particularly for those who cannot properly or adequately cleanse themselves. This situation affects not only the dignity and comfort of those requiring assistance but also creates challenging circumstances for their caretakers who must perform these intimate hygiene tasks.

The impact extends beyond just the affected individuals themselves. Caretakers often become necessarily involved in these intimate hygiene tasks, creating potentially uncomfortable situations for both parties involved. This arrangement, while necessary under current circumstances, highlights the pressing need for solutions that could restore some degree of independence and dignity to those requiring assistance.

These hygiene challenges are particularly concerning because they can lead to additional health and safety risks. For instance, when individuals attempt to use traditional cleaning methods like bathtubs or showers, they may expose themselves to significant risks of slip and fall injuries, especially among the elderly population. Currently, these individuals often must rely on caretakers to assist with cleaning after urination or defecation. This creates an uncomfortable situation for both the person requiring care and the caretaker who must perform these intimate hygiene tasks.

The reliance on caretakers for intimate hygiene tasks creates numerous challenges and undesirable circumstances for both parties involved. Caretakers must undertake the unenviable responsibility of cleansing individuals who are unable to clean themselves after urinating or defecating. This intimate care requirement places caretakers in a physically and emotionally demanding position. They must perform these personal hygiene tasks using traditional methods that typically involve removing diapers and manually cleansing the individual with wipes.

When alternative cleaning methods are required, caretakers face additional challenges and risks. They may need to assist individuals with cleaning in the bathtub or shower, which not only increases the physical demands on the caretaker but also exposes both the caretaker and the person receiving care to potential slip and fall hazards. This risk is particularly concerning when assisting elderly individuals.

The situation creates a complex dynamic where caretakers must balance providing necessary care while maintaining the dignity of those they assist. Whether the care is needed due to age-related limitations, disability, post-surgical recovery, or other physical constraints, caretakers must regularly perform these intimate hygiene tasks despite the uncomfortable nature of the situation for all parties involved.

These challenges affect not only those who need assistance due to physical limitations, but also individuals recovering from surgery or those who simply require additional help with personal hygiene. The current solutions are inadequate, creating a clear need for an improved method to assist people with personal cleansing, particularly for those who cannot properly or adequately cleanse themselves. There remains an unmet need in association with cleansing persons after urination or defecation, in particular when such persons are unable to cleanse themselves. Seated shower cleansing from an effective bathing device remains desirable to provide for comfortable, easy cleaning. An effective water delivery system likewise remains desirable as such a design could focus on cleaning and providing pleasurable sensations as desired, further enhancing quality of life for users with physical limitations.

Prior art bathing devices, including those designed for use with chairs, wheelchairs, or hospital furniture, may incorporate upward-facing jets or drainage openings individually, but do not disclose or suggest the critical functional relationship between drainage capacity and water supply volume that is central to the present invention. Prior art chair-mountable hygiene devices teach general water spray configurations without regard to whether the aggregate drainage capacity matches or exceeds the water supply rate, resulting in water pooling, pressure loss, and ineffective cleaning. Furthermore, prior art devices do not disclose a modular snap-in compartment architecture enabling tool-free exchange of functional modules including water jet compartments, cleaning solution reservoir compartments, and alternative shower head attachment compartments. The present invention addresses these deficiencies by providing a device wherein drainage is engineered as a primary design parameter, not an afterthought, and wherein the functional configuration of the device is user-adjustable through interchangeable modular compartments without disassembly or specialized tools.

### SUMMARY OF THE INVENTION

The preferred embodiment provides a furniture-attachable bathing device featuring a diamond-pattern water supply and drainage system integrated with strategically positioned water jets. A critical innovation is the paired relationship between upward-facing water jets and drainage volume capacity: the jets are configured to direct pressurized water flow upward against gravity toward intimate areas, while drainage openings are configured with collective volume capacity sufficient to evacuate water at a rate equal to or exceeding the water output rate of the jets, preventing water accumulation that would inhibit jet spray pressure. The water jet outlets are sized with diameters configured to distribute water pressure over sufficient skin surface area to provide effective cleaning or stimulation force without causing pain to sensitive tissue. The device incorporates a streamlined design utilizing the diamond-pattern water supply and drainage system, eliminating internal soap reservoirs while optimizing water delivery and evacuation. The device features a distinctive three-tier attachment system comprising corner strap holes, side oblong holes, and lateral attachment mechanisms that enable universal compatibility with chairs, toilet seats, hospital beds, and animal washing platforms. The device enables multiple applications including hygienic cleaning for users with physical limitations, washing of small companion animals, and therapeutic intimate stimulation for users unable to manually stimulate themselves due to disability. Water jets are configured in zones, with forward-facing jets for genital areas and rear-facing jets for buttocks regions. The system features selective jet activation capability, enabling users to deactivate outer jets while maintaining central jets to concentrate water pressure for enhanced stimulation. Additional specialized jets accommodate hair washing capabilities and lateral body cleaning while the user remains safely seated. The device's versatile functionality addresses hygiene, therapeutic, animal care, and intimate wellness needs through common underlying innovations in water delivery, pressure control, drainage capacity, and pain-prevention jet sizing.

The device's versatile attachment system allows secure mounting to various support structures including chairs, wheelchairs, toilets, hospital beds, and conventional beds. In an embodiment, the device may be provided with a corresponding chair specifically designed with waterproof materials and proper mounting points.

The invention has been recognized by the inventor as particularly beneficial for individuals with physical limitations, people recovering from surgery, and those requiring additional assistance with bathing. It addresses longstanding hygiene challenges by enabling effective cleaning while maintaining user dignity and safety in a seated position. The device eliminates the need for potentially hazardous traditional bathing methods and reduces dependence on direct caretaker assistance for intimate hygiene tasks.

The integrated water distribution system ensures proper water delivery through precisely angled water jets, maintaining consistent functionality across all mounting configurations. The strategic positioning of these water jets enables effective cleaning while the streamlined design, which eliminates the need for soap dispensing, optimizes water flow distribution for maximum effectiveness. In accordance with an exemplary embodiment, the system further comprises a lateral water stream configuration that projects water from positions external to the user's leg placement, creating arcing streams that provide comprehensive intimate area coverage without requiring internal seat-based water channels as found in conventional designs. This approach provides superior drainage through the diamond hole pattern while eliminating the complexity and hygiene concerns associated with internal soap mixing systems.

### BRIEF DESCRIPTION OF THE FIGURES

FIG. 1 provides a top plan view of the chair-attachable bathing device showing the overall device body, lateral blasters, genital area blasters, drainage holes, strap attachment holes, side attachment piece, blaster attachment bodies, center genital area attachment body, and tilted drainage region in accordance with an embodiment of the invention.

FIG. 2 provides a bottom plan view of the chair-attachable bathing device showing the underside arrangement of drainage aspects, strap attachment apertures, side attachment piece, water channel pipes, blaster attachment bodies, and center genital area attachment body in accordance with an embodiment of the invention.

FIG. 3 provides a front view of the chair-attachable bathing device highlighting the side attachment piece and water inlet configuration in accordance with an embodiment of the invention.

FIG. 4 provides a side view of the chair-attachable bathing device in accordance with an embodiment of the invention.

FIG. 5 provides a side view of the chair-attachable bathing device positioned on a chair, illustrating attachment to a support structure in accordance with an embodiment of the invention.

FIG. 6 provides a top perspective view of the chair-attachable bathing device mounted to a chair, showing the arrangement of lateral blasters, genital area blasters, drainage holes, blaster attachment bodies, strap attachment holes, straps, and the side attachment piece in accordance with an embodiment of the invention.

FIG. 7 depicts a user positioned on the chair-attachable bathing device mounted to a chair demonstrating the device positioned in operational configuration for intimate area cleaning in a seated position in accordance with an intended use of an embodiment of the invention.

FIG. 8 depicts a user positioned on the chair-attachable bathing device illustrating the device functionality in a reclined or lying position, as shown in accordance with exemplary use by a person laying in a hospital bed without attachment to a chair, in accordance with an embodiment of the invention.

FIG. 9 depicts a separated view of the water jets and an intended orientation of lateral blasters and genital area blasters in accordance with an embodiment of the invention.

FIG. 10 provides a partially exploded view of the chair-attachable bathing device configuration including lateral blasters, genital area blasters, blaster attachment bodies, center genital area attachment body, water channel pipes, and side attachment piece in accordance with an embodiment of the invention.

FIG. 11 depicts a partially exploded view chair-attachable bathing device configuration showing drainage holes, blaster attachment bodies, attachment joining members, center genital area attachment body, water channel pipes, and side attachment piece in accordance with an embodiment of the invention.

FIG. 12 depicts a perspective view of a seated use configuration illustrating water streams projected from lateral blasters and genital area blasters toward various corresponding areas of a person during an intended use in accordance with an embodiment of the invention.

FIG. 13 depicts a front view of a seated use configuration illustrating water streams projected from lateral blasters and genital area blasters toward various corresponding areas of a person during an intended use in accordance with an embodiment of the invention.

FIG. 14 depicts a side cross-sectional view of a chair-attachable bathing device showing the diamond-pattern drainage holes, lateral blasters, blaster attachment bodies, center genital area attachment body, tilted drainage region, and attachment joining members in accordance with an embodiment of the invention.

FIG. 15 depicts an exemplary hospital bed system configuration including the chair-attachable bathing device, bed, cone, and plastic sheet overlay in accordance with an embodiment of the invention.

### DETAILED DESCRIPTION

The preferred embodiment of the present invention provides a chair-attachable bathing device (100) that enables a user and his or her caretaker to clean the user's body, and in particular the user's genital and buttocks areas, while remaining seated. The device comprises several core components working in concert to provide an effective bathing solution for individuals with physical limitations, those recovering from surgery, or anyone needing additional assistance with personal hygiene.

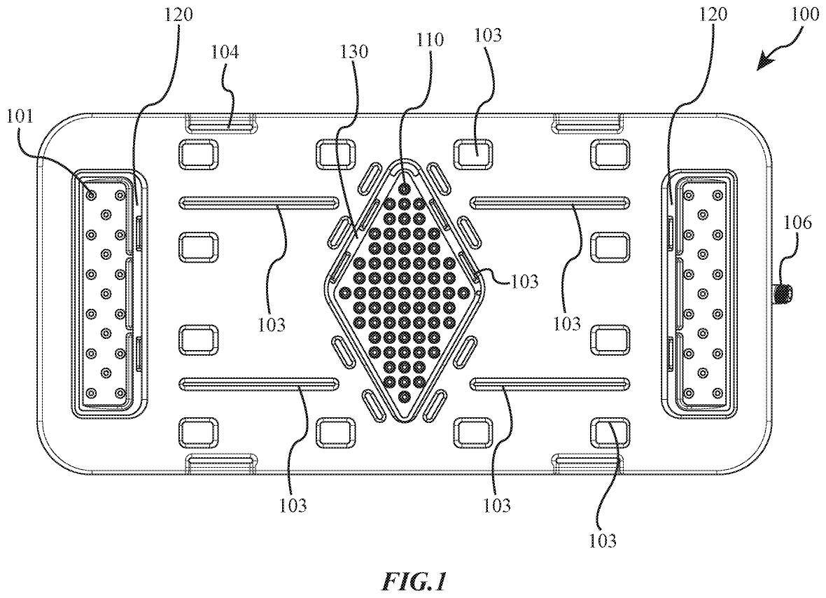

FIG. 1 depicts the chair-attachable bathing device (100) in accordance with an embodiment of the invention, showing the overall system configuration from a top plan view. The device (100) comprises strategically positioned water jets including lateral blasters (101) and genital area blasters (110), drainage holes (103), strap attachment holes (104), a side attachment piece (106), modular blaster attachment bodies (120), and a center genital area attachment body (130). The tilted drainage region associated with the center genital area attachment body (130) directs water toward the drainage holes (103), working in concert with the aggregate drainage capacity principle to continuously evacuate water from the upper surface during operation without pooling.

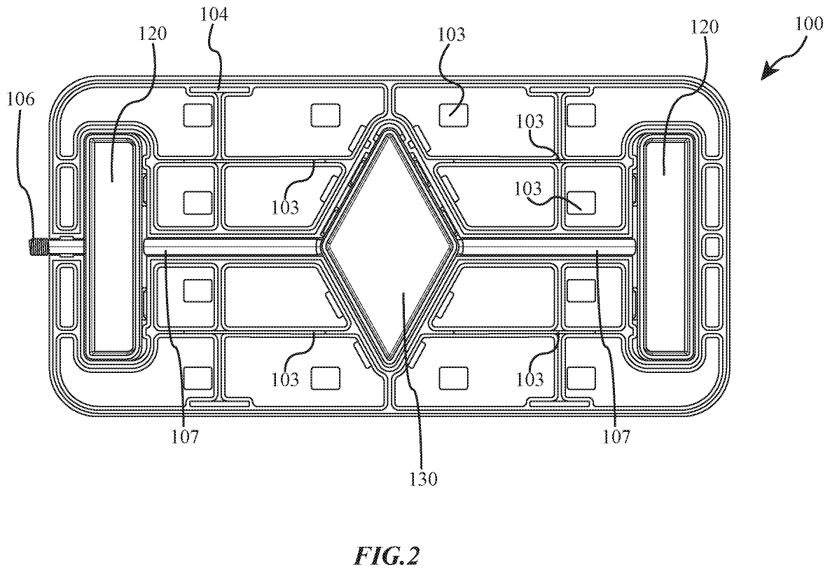

FIG. 2 provides a bottom plan view of the chair-attachable bathing device (100) in accordance with an embodiment of the invention, demonstrating the underside arrangement of water distribution and attachment features. The strap attachment holes (104), side attachment piece (106), water channel pipes (107), blaster attachment bodies (120), center genital area attachment body (130), and drainage holes (103) are visible from the underside. The water channel pipes (107) distribute water from the side attachment piece (106) toward the jet regions while maintaining the critical functional relationship between water supply and drainage capacity.

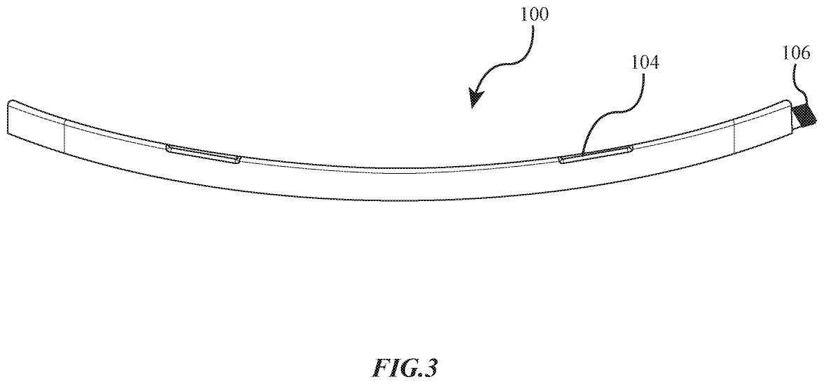

FIG. 3 shows the chair-attachable bathing device (100) in accordance with an embodiment of the invention in a front view, highlighting the side attachment piece (106) and strap attachment hole (104). This figure demonstrates the water inlet configuration that receives water from an external source through a shower hose connection meeting shower hose standards. The side attachment piece (106) incorporates a standardized threading system ensuring that the device can be readily connected to existing shower infrastructure without requiring specialized adapters.

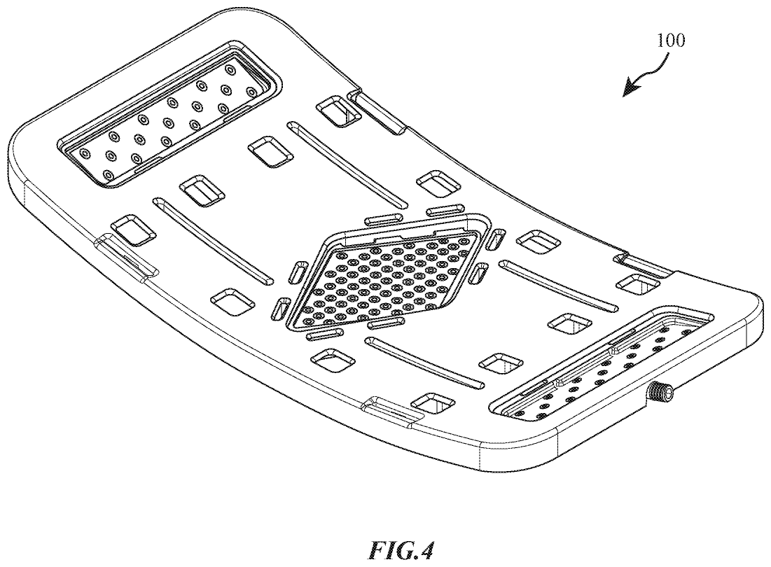

FIG. 4 depicts a side view of the chair-attachable bathing device (100) in accordance with an embodiment of the invention. The side-view configuration illustrates the thickness and profile of the device body and the manner in which the upper support surface is positioned relative to the lower surface during use.

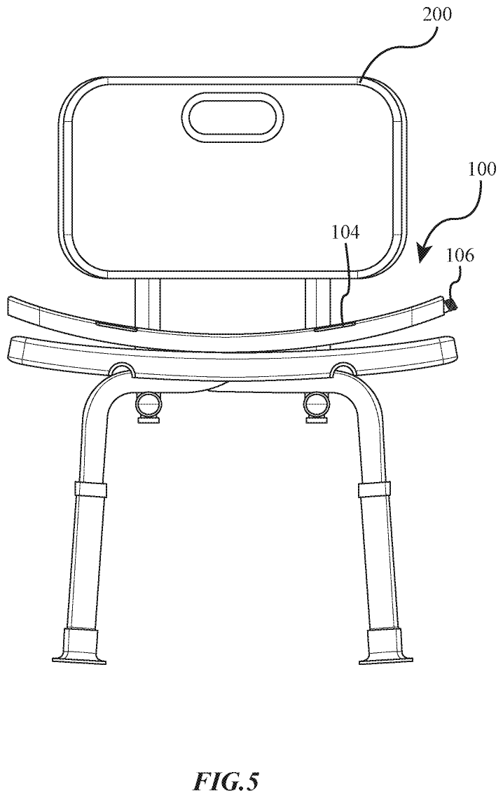

FIG. 5 depicts the chair-attachable bathing device (100) positioned upon a chair (200) in accordance with an embodiment of the invention, illustrating a mounted configuration. A strap attachment hole (104) and the side attachment piece (106) are visible, demonstrating how the device interfaces with a chair or other support structure while maintaining proper positioning of the water delivery and drainage features relative to a seated user.

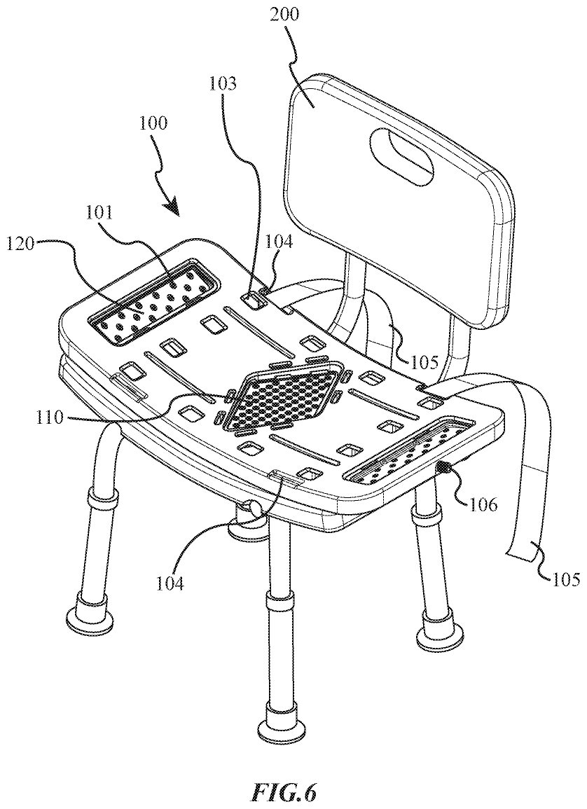

FIG. 6 provides a top perspective view of the chair-attachable bathing device (100) mounted to a chair (200) in accordance with an embodiment of the invention, showing the complete arrangement of functional components. The lateral blasters (101), genital area blasters (110), drainage holes (103), modular blaster attachment bodies (120), strap attachment holes (104), straps (105), and side attachment piece (106) demonstrate the strategic positioning of water jets, drainage features, and attachment components. The drainage holes (103) provide the diamond-pattern drainage system that enables rapid water evacuation without standing water issues, with collective volume capacity sufficient to evacuate water at a rate equal to or exceeding the water output rate of the upward-facing water jets.

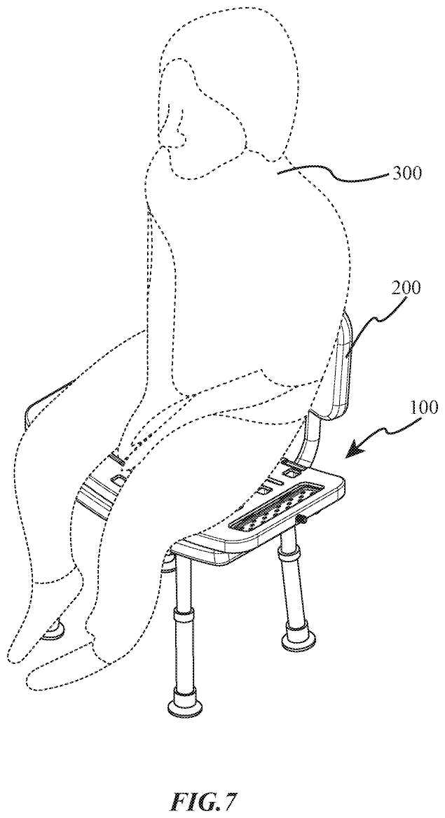

FIG. 7 depicts a user (300) positioned on the chair-attachable bathing device (100) mounted to a chair (200) in accordance with an intended use of an embodiment of the invention, demonstrating the device in operational configuration for intimate area cleaning while the user remains seated. This configuration enables upward-facing water jets to direct pressurized water flow upward against gravity toward intimate areas while the user's body weight and positioning create the partial enclosure that necessitates the coordinated drainage capacity.

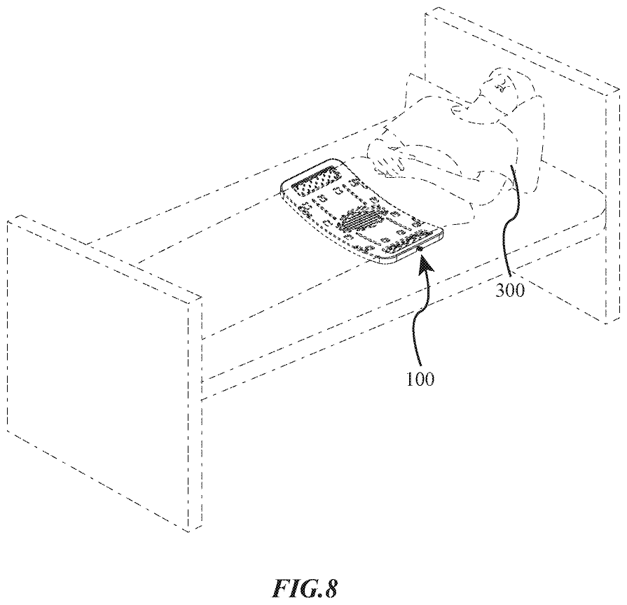

FIG. 8 depicts an alternative use configuration with a user (300) positioned on the chair-attachable bathing device (100) in accordance with an embodiment of the invention, illustrating the device functionality in a reclined or lying position. This configuration demonstrates the versatility of the device for users who may require alternative positioning due to physical limitations or recovery needs, while maintaining the same water delivery and drainage effectiveness.

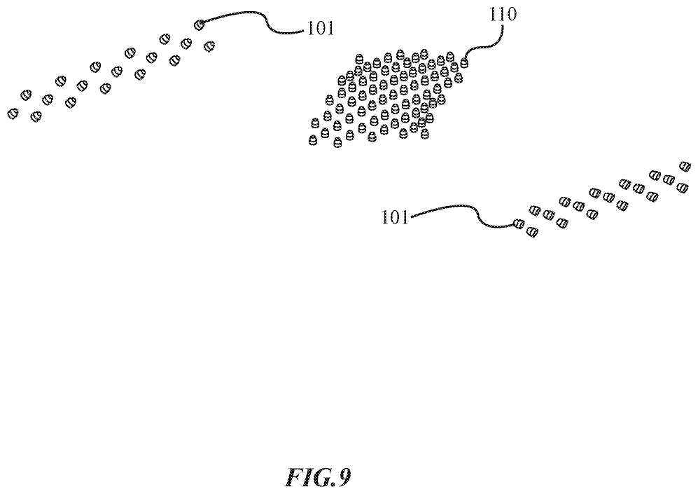

FIG. 9 depicts the water jets arranged in an intended exemplary configuration in accordance with an embodiment of the invention, illustrating lateral blasters (101) and genital area blasters (110). The figure demonstrates positioning of the jets to direct water streams toward different target regions of the user, including lateral body regions and genital or buttocks regions.

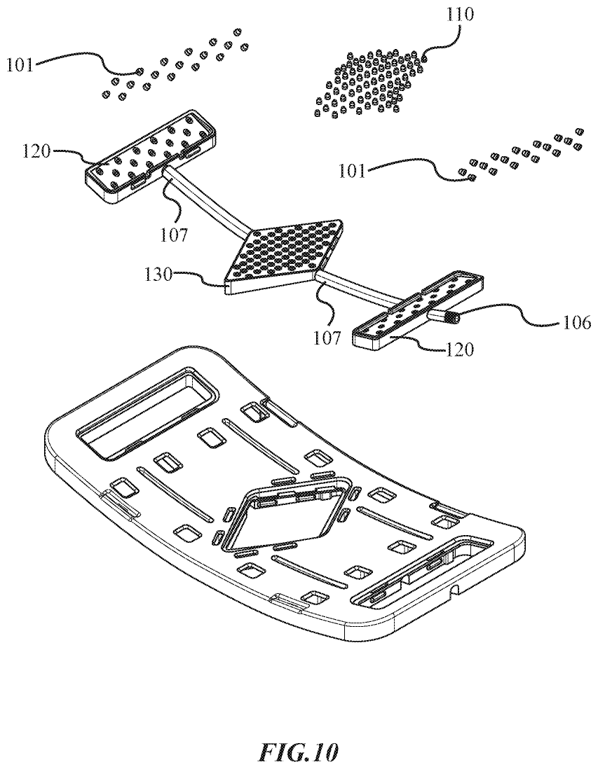

FIG. 10 illustrates the chair-attachable bathing device (100) in accordance with an embodiment of the invention, showing a configuration including lateral blasters (101), genital area blasters (110), modular blaster attachment bodies (120), a center genital area attachment body (130), water channel pipes (107), and side attachment piece (106). This figure demonstrates the relationship between the water channel pipes and the jet-bearing attachment bodies through which water is distributed to the lateral and central jet regions.

In an embodiment, the diamond-pattern central drainage area extends to a vertical height of approximately nine inches from the front to the rear of the device body, sized to accommodate the seated anatomy of adult users across a range of body types while providing comprehensive intimate area coverage. The central drainage area incorporates a first tilt angle directed toward the drainage holes, causing water delivered by the genital area jets to flow gravitationally toward the drainage apertures immediately upon contact with the seat surface rather than pooling. The lateral jet areas of the device incorporate a second tilt angle, also directed toward the drainage apertures, ensuring that water delivered by the lateral blasters is likewise evacuated through the drainage system. The combination of the first tilt angle in the central drainage area and the second tilt angle in the lateral areas works in concert with the aggregate drainage capacity principle to provide continuous, active water evacuation from the entire upper surface of the device during operation, maintaining consistent jet pressure and preventing water accumulation that would reduce cleaning effectiveness.

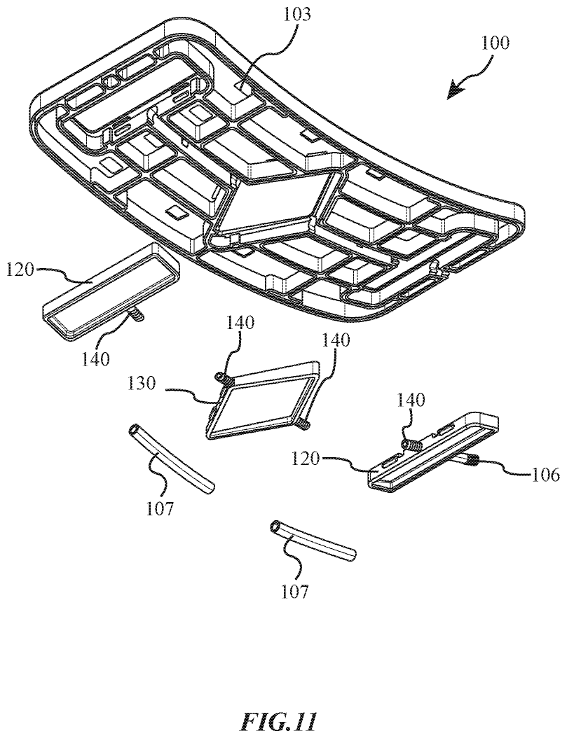

FIG. 11 depicts a chair-attachable bathing device (100) configuration in accordance with an embodiment of the invention, showing drainage holes (103), modular blaster attachment bodies (120), attachment joining members (140), center genital area attachment body (130), water channel pipes (107), and side attachment piece (106). The attachment joining members (140) connect or stabilize adjacent attachment bodies and cooperate with the device body to maintain alignment of the modular jet components and drainage features.

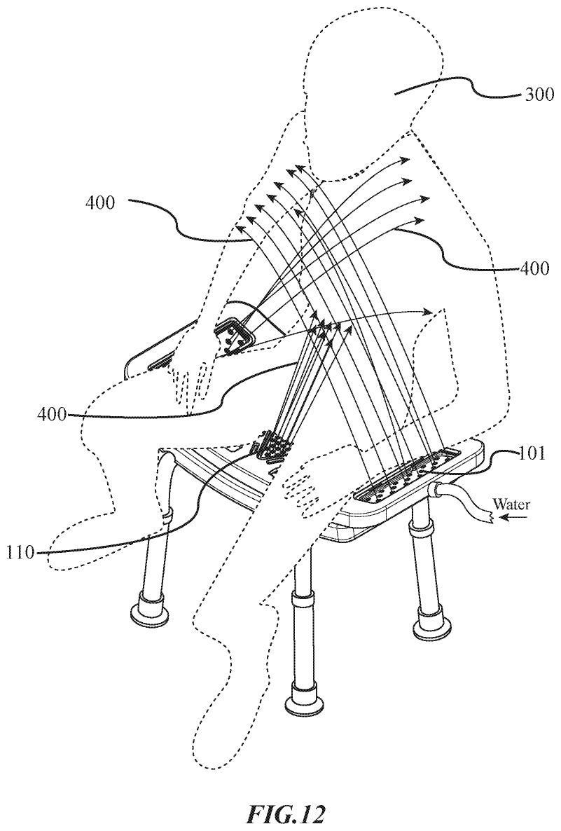

FIG. 12 depicts an exemplary seated use configuration in accordance with an embodiment of the invention, illustrating water streams (400) projected from lateral blasters (101) and genital area blasters (110) toward a person (300). The water streams (400) demonstrate arcing trajectories that provide body coverage while the user maintains a seated position, including intimate area water stream coverage through the lateral and central water stream configuration.

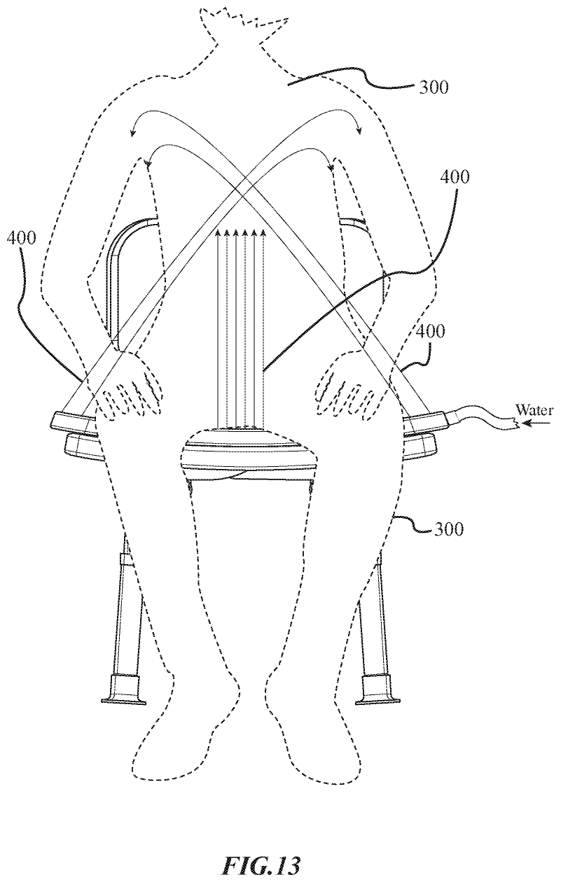

FIG. 13 depicts a front view of an exemplary seated use configuration in accordance with an embodiment of the invention, illustrating water streams (400) projected toward a person (300). The configuration demonstrates operation of the water delivery system for a user in a reclined or lying position, including projection of water streams for body coverage without requiring the user to stand.

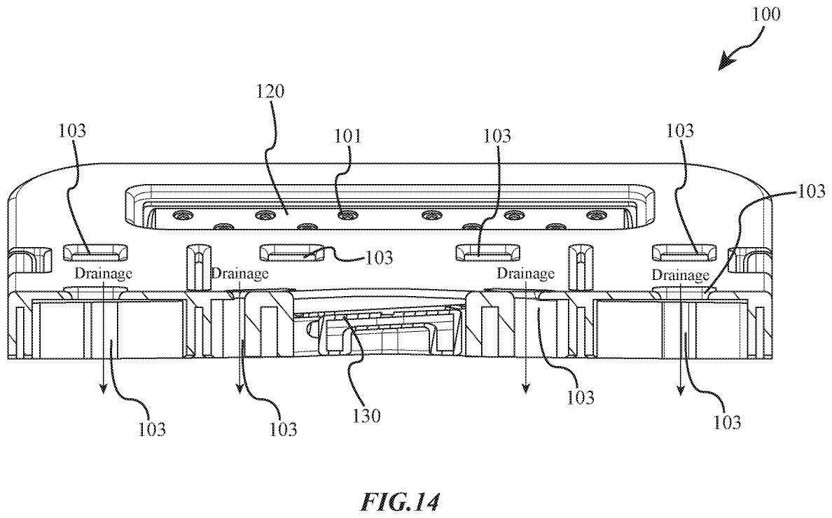

FIG. 14 depicts a side cross-sectional view of the chair-attachable bathing device (100) in accordance with an embodiment of the invention, showing the diamond-pattern arrangement of drainage holes (103), lateral blasters (101), modular blaster attachment bodies (120), center genital area attachment body (130), tilted drainage region, and attachment joining members (140). This enlarged view further illustrates the coordinated relationship between the drainage apertures and jet-bearing components that provides rapid water evacuation while maintaining upward jet performance.

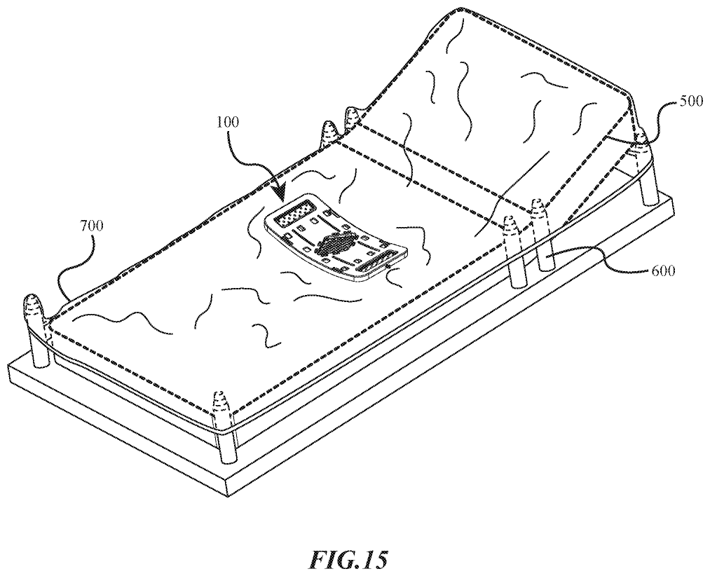

FIG. 15 depicts an exemplary hospital bed system configuration in accordance with an embodiment of the invention, showing the integration of the chair-attachable bathing device (100) with a bed (500), cone (600), and plastic sheet overlay (700). The bed (500) represents a hospital bed application where the device provides mobile hygiene solutions for bedridden patients. The cone (600) demonstrates a specialized positioning component that helps maintain proper alignment between the user and the water jet system, and the plastic sheet overlay (700) channels water and waste away from the bed surface while maintaining sanitary conditions through the coordinated drainage system.

The chair-attachable bathing device is manufactured using a precision injection molding process that creates the integrated seat structure with its complex internal water distribution channels and surface features in a single molded piece. The injection molding process begins with the creation of a multi-part mold that defines both the external seat geometry and the internal channel network that houses the water distribution system. During molding, thermoplastic material is injected under pressure to form the seat structure with precisely angled water jet openings, the diamond-pattern drainage holes (103), and the internal channels of varying thicknesses that enable water to flow from the inlet (106) through the bar structures (105) to supply the jet system throughout the device. The molding process creates thin internal spaces at different thicknesses that form the water distribution channels, while simultaneously forming the exterior mounting features including strap holes and attachment points that enable secure connection to various support structures. This single-step manufacturing approach ensures consistent wall thicknesses, proper jet angles, and precise drainage hole positioning while maintaining the structural integrity required to support user weight during operation.

In accordance with an embodiment, the device comprises a closed main body defining a plurality of compartment receptacles, and a plurality of modular compartments configured to be removably received within the compartment receptacles through a snap-fit engagement. The closed main body houses the internal water distribution channels and drainage pathways, while each modular compartment provides a discrete functional capability that is fluidly connected to the main body's water supply and drainage systems upon insertion. The snap-fit engagement enables each compartment to be installed and removed by hand without requiring tools, permitting rapid reconfiguration of the device for different operational modes. Each compartment, when fully seated in its receptacle, forms a fluid-tight connection with the main body's internal water distribution system and drains independently through the device's drainage system. The modular compartment interface openings (120) define the receptacle locations within the device body, each opening configured with a snap-fit engagement profile and fluid connection ports for water supply and drainage.

In accordance with embodiments, the interchangeable modular compartments comprise at least the following types: a standard water jet compartment housing one or more upward-facing water jets configured to direct pressurized water toward the user; a soap or cleaning solution reservoir compartment configured to store and dispense soap or cleaning solution through the device's water delivery pathways; a secondary shower head attachment compartment incorporating a nozzle having a diameter of approximately one-half inch and configured to receive a small diamond-pattern shower head that plugs into the device to provide supplemental water delivery; and a pressure-redirecting or blanking module configured to block water flow to the compartment location, thereby redirecting available water pressure to remaining active compartments. Additional compartment types may be provided to address specialized functional requirements while maintaining compatibility with the common snap-fit interface of the main body. Each compartment type drains independently through the device's integrated drainage system, and the aggregate drainage capacity of the drainage apertures (103) is maintained at a level exceeding the total volumetric flow rate regardless of which combination of compartment types is installed.

In accordance with a further embodiment, the selective removal of one or more lateral jet compartments from the main body redirects the full available water pressure to the remaining active compartments, including central compartments directed toward genital areas, thereby providing enhanced stimulation intensity through concentrated water pressure. This pressure redistribution occurs passively as a consequence of the modular architecture—when a lateral compartment is removed and a blanking module is not inserted, the water supply port for that receptacle may be sealed by the main body's internal valve structure, concentrating all available pressure through the remaining active jets. Alternatively, when a blanking module is inserted, the module physically blocks water flow to the receptacle location, achieving the same pressure concentration effect. Additionally, the device in an embodiment incorporates a hard plastic internal tube having an outer diameter of approximately three-eighths of an inch that creates a pressure-actuated seal when the user sits upon the device. The user's body weight engages the tube with a corresponding valve seat to establish a fluid-tight seal within the internal water distribution system, preventing water leakage and maintaining system pressure during operation.

In an embodiment, water distribution within the device is accomplished through a hard plastic internal tube having an outer diameter of approximately three-eighths of an inch, positioned beneath the device body within the internal water distribution system. The internal tube is configured to establish a pressure-actuated sealing engagement with the device's water distribution channels as the user assumes the seated position on the device. When the user's weight is applied to the device body, the resulting pressure causes the internal tube to seat against the distribution channel walls, creating a water-tight seal that maintains internal water pressure without requiring separate mechanical sealing components. This pressure-actuated sealing mechanism enables the device to establish and maintain water pressure through the user's own body weight, and the seal releases upon the user rising from the device, enabling easy disconnection without tools.

For purposes of this disclosure, certain terms are defined as follows. “Intimate areas” or “intimate area cleaning” may refer to the genital and buttocks regions of the user's body, which are the primary target areas for the water delivery system when the device is used for personal hygiene purposes. “Full body wash coverage” or “full body cleaning” refers to the capability of the lateral water streams to reach areas beyond the intimate regions, including the user's shoulders, back, chest, and legs while the user maintains a seated or reclined position. “Lateral water streams” refers to water jets positioned outside the areas where the user's legs are positioned when seated, which can project water in trajectories that arc over or around and downward onto the legs and other areas of the body to reach cleaning targets. “Bar structures” refers to elongated structural members that serve the dual function of providing physical weight support for the device and housing internal channels through which water travels to supply the jet system. “Bidirectional water distribution system” refers to the internal channel configuration wherein water entering the inlet automatically divides and flows in two directions simultaneously through the bar structures to supply jets throughout the device. “Diamond-pattern drainage” or “diamond drainage holes” refers to the arrangement of drainage openings across the seat surface in a diamond or rhombus-shaped pattern that provides multiple exit points for efficient water evacuation. “Sequential filling” refers to the water flow characteristic wherein outside jets receive and dispense water before the diamond drainage holes fill with water, optimizing pressure distribution throughout the system. “Water pressure optimization” refers to the design features that minimize internal void space within the water supply channels and reservoir to maximize available water pressure from standard residential or commercial water sources. “Dual functionality” or “dual function” when referring to structural components means that a single element serves two distinct purposes simultaneously, such as providing both structural support and serving as a water distribution conduit. “Blaster” refers to a water jet, nozzle, outlet, or similar water-delivery structure configured to emit a directed stream of water from the device toward a target cleaning or stimulation area.

At its core, the device in a preferred embodiment comprises a versatile connector system that enables attachment to both shower hoses and faucets for water supply. The integrated water distribution system in an embodiment may optionally incorporate a water pressure control mechanism. In an exemplary embodiment, this comprises a half-moon shaped dial specifically engineered for users with hand mobility limitations such as neuropathy, arthritis, and other physical impairments. This control allows users to adjust water flow intensity by simply rubbing their hand across the dial's surface, ensuring accessibility and ease of use even for those with limited manual dexterity. Alternatively, the device may be operated with commercially available external water pressure regulators connected between the water source and the device inlet, providing equivalent pressure adjustment functionality without requiring an integrated mechanism. The streamlined design optimizes water flow distribution through precisely positioned water jets.

In a preferred embodiment, the device serves as a comprehensive bathing solution specifically designed to address the hygiene needs of individuals with physical limitations that prevent adequate self-cleaning. The device enables these individuals to maintain proper hygiene while remaining in a stable seated position, reducing dependence on caretakers for intimate cleaning tasks.

For people recovering from surgery, a preferred embodiment provides a cleaning solution that eliminates the need for potentially hazardous bathing methods. The device's seated operation and controlled water delivery system enables post-surgical patients to maintain proper hygiene without risking injury or compromising surgical sites.

The device particularly serves individuals requiring additional assistance with bathing tasks by providing an automated cleaning system that maintains user dignity and independence. Through its integrated water jet system and pressure controls, the preferred embodiment enables effective cleaning while minimizing the need for direct caretaker assistance in intimate hygiene tasks.

The primary focus of the preferred embodiment centers on cleaning genital and buttocks areas while the user remains seated. This is accomplished through strategically positioned water jets that direct precisely controlled streams of water and cleaning solution to intimate areas. The device's design enables thorough cleaning of these areas without requiring the user to stand or transfer to traditional bathing facilities, thereby addressing the long-felt need for a safe and effective seated bathing solution.

In one embodiment, the device's functionality extends beyond basic cleaning to provide comprehensive hygiene care, including specialized jets configured for hair washing capabilities. This multi-purpose design ensures that users with various physical limitations or recovery needs can maintain complete personal hygiene while remaining in a safe, stable seated position.

A key feature of the invention in a preferred embodiment is its integrated system of water jets, which are strategically built within the seat. These jets are designed to direct water flow through specifically angled holes in the seat, enabling targeted cleaning of intimate areas while the user remains seated. The same jet technology is additionally configured to accommodate hair washing for female users.

As used herein, the term “intimate areas” may also refer to the genital area and buttocks area of a user that require cleaning after urination or defecation. These areas present particular hygiene challenges for individuals with physical limitations, those recovering from surgery, or others requiring assistance with personal care. The intimate areas specifically encompass those regions of the body that must be cleansed for proper hygiene after using the bathroom, and which traditionally require either manual cleaning with wipes or bathing in a shower or tub to maintain adequate cleanliness.

The device's versatility is enhanced through multiple attachment points that enable secure mounting to various surfaces and furniture pieces. This design allows the device to be attached to different support structures including standard chairs, wheelchairs, toilets, hospital beds, and conventional beds, making it adaptable to various use scenarios and environments.

In an embodiment, the device integrates with a specialized plastic sheet overlay (700) designed for hospital bed applications (500). This system enables the bathing device (100) to be positioned over bedridden patients while the plastic sheet (700) channels water and waste away from the bed surface. The combination provides a mobile hygiene solution that can serve multiple patients while maintaining sanitary conditions through the integrated drainage system. The combination of the bathing device (100), plastic sheet overlay (700) specifically corresponding to a hospital bed provides a mobile hygiene solution that can serve multiple patients while maintaining sanitary conditions through the integrated drainage system as a whole, as depicted in the system comprising such components as depicted in FIG. 15.

In a preferred embodiment, the device may be integrated with a specialized rubber structure designed for use with hospital furniture, such as hospital beds. In one exemplary embodiment, the device comprises or is designed to interact with a seat structure. In an exemplary embodiment, this rubber overlay features six elevation points that raise the structure above the bed surface, creating an optimized configuration for the bathing system. The preferred embodiment comprises a built-in drainage system at the lowest point of the rubber structure, utilizing suction to efficiently remove water during and after use. The bathing device itself is designed to slide underneath the patient within this rubber structure, enabling effective cleaning of a person's anatomy through the integrated water jet system. This mobile configuration allows the system to serve multiple patients, providing a more thorough cleaning alternative to traditional scrub baths. The suction-assisted drainage system minimizes residual moisture, reducing the need for extensive drying procedures after use. The rubber structure's adaptable design maintains proper positioning of users relative to the water jets while ensuring comfort and safety throughout the bathing process.

In a preferred embodiment, the core components work in concert to enable effective intimate area cleaning while maintaining user comfort and dignity. These components include a connector that interfaces with a standard shower hose for water supply and, optionally, a water pressure control mechanism that enables adjustment of water flow intensity. An alternative embodiment further incorporates a soap dispenser and soap control switch for regulated dispensing of cleaning solution, and a system of strategically positioned water jets built within the device structure. These jets are configured to direct water flow through specifically angled holes to achieve optimal cleaning effectiveness. Where the device does not include an integrated water pressure control mechanism, the device is compatible with commercially available external water pressure regulators that may be connected between the water source and the device inlet. The plurality of attachment points are integrated into the device's structure to ensure secure mounting to various support surfaces, enabling stable operation during use.

The hose water connection (106) in an exemplary embodiment comprises a shower hose meeting shower hose standards in accordance with an exemplary embodiment to facilitate interaction with most shower heads. The standard for most shower hoses is a ½-inch thread on both ends, compatible with most shower fixtures. Standard connectors are ½″ NPT (National Pipe Thread) in the United States, or G½″ in other regions, and are usually compatible with global fittings to ensure universal applicability across different plumbing systems. New hoses should come with rubber gaskets to ensure a proper seal and prevent leaks at connection points. High-quality hoses are often made of materials like 304 stainless steel with brass fittings, which are durable and corrosion-resistant, providing long-term reliability in wet environments. The standardized threading system ensures that the device (100) can be readily connected to existing shower infrastructure without requiring specialized adapters or modifications, thereby enhancing the device's accessibility and ease of installation for users with physical limitations who may have difficulty with complex setup procedures.

In a preferred embodiment, the connector comprises an interface adapted to couple with a standard shower hose to enable water flow into the device. The connector is configured to provide a secure, water-tight connection between the external water source and the device's internal components, including the water pressure control mechanism and the system of water jets. In one embodiment, the connector enables water from the shower hose to be directed through the device's internal channels to supply the strategically positioned jets within the seat structure.

In a preferred embodiment, the connector may include a standard threaded fitting compatible with common shower hose connections, such as a ½ inch or ¾ inch NPT (National Pipe Thread) fitting. The connector assembly can comprise a threaded female receptor configured to receive the male end of a standard shower hose, with an internal gasket or O-ring to ensure a watertight seal. In one embodiment, the connector interfaces with internal water channels that direct flow through a manifold system and, when present, through an optional water pressure control mechanism, before distributing water to the individual jets positioned within the device structure. Where an integrated pressure control mechanism is not present, an external water pressure regulator may be connected between the water source and the device inlet to provide equivalent pressure adjustment capability. The connection point may be reinforced and sealed with waterproof materials to prevent leakage where the hose connector interfaces with the device's internal water distribution system.

In a preferred embodiment, the water pressure control mechanism enables adjustment of water flow intensity through the device's jet system to accommodate user comfort and cleaning effectiveness. The water pressure control interfaces with the water supply from the shower hose connector and regulates the pressure of water delivered to the strategically positioned jets within the seat structure.

In a preferred embodiment, the water pressure control may include an adjustable valve mechanism that enables variable control over water flow rates. The control system can incorporate a pressure regulator to maintain consistent water pressure regardless of input pressure variations from the water source. In one embodiment, the pressure control mechanism connects to the water distribution manifold between the shower hose connector and the jet system, allowing for precise adjustment of water pressure before distribution to individual jets within the seat structure. The pressure control in an exemplary embodiment features user-accessible adjustment controls positioned for convenient operation while the device is in use.

In a preferred embodiment, the water jets are incorporated within the seat structure to enable targeted cleaning of intimate areas while the user remains seated. The jets are configured with specifically angled holes through the seat surface to direct water flow at optimal angles for effective cleaning. In one embodiment, the jet system works in coordination with both the water pressure control mechanism and a soap dispensing system to deliver a controlled mixture of water and cleaning solution through the precisely positioned outlets.

In a preferred embodiment, the water jets are arranged in a pattern across the seat surface with outlets positioned to direct water flow upward and slightly forward or backward depending on the area to be cleansed. The jet outlets are integrated into the seat structure with holes angled to create intersecting water streams that provide thorough coverage of the genital and buttocks areas while the user remains seated.

In an exemplary embodiment, the jets are configured in multiple zones within the seat, with forward-facing jets angled to direct water flow for cleansing the genital area, while rear-facing jets are positioned to clean the buttocks region. This strategic positioning of angled jets enables targeted cleaning of intimate areas that traditionally require manual cleansing or bathing.

In one embodiment, the water streams from multiple jets converge to create optimal cleaning coverage while maintaining comfortable water pressure through the pressure control system. The arrangement allows for effective cleansing while the user maintains a stable seated position, addressing the hygiene needs of individuals with physical limitations or those requiring assistance.

In a preferred embodiment, the jet system incorporates supplementary outlets positioned and angled specifically to accommodate hair washing needs of female users. These additional jets are integrated into strategic locations within the seat structure, in an example to direct water flow upward at calculated angles that facilitate hair cleaning while maintaining the user in a comfortable seated position.

A critical aspect of the present invention in an embodiment is the configuration of water jet outlet diameters to prevent pain or discomfort while maintaining effective cleaning and/or stimulation. The present inventor has discovered that high-pressure water delivery through very small diameter jets, while capable of providing cleaning force, causes significant discomfort or pain when applied to sensitive intimate tissue.

This pain results from excessive force per unit area. When water under pressure exits through a small opening, the resulting narrow stream concentrates its force over a very small contact area on the skin. For example, a water stream of 2 mm diameter at 30 PSI pressure delivers force over an area of only approximately 3.14 square millimeters. When applied to sensitive genital or anal tissue in particular, this concentrated force causes sharp, stinging pain that makes the device unusable for its intended purpose.

The present invention in an embodiment solves this problem by configuring water jet outlets with diameters sized to distribute water pressure over sufficient surface area to remain below pain thresholds while maintaining cleaning effectiveness. In a preferred embodiment, jet outlet diameters are sized such that even at maximum operating pressure, the force per unit area of skin contact remains comfortable. By way of non-limiting example, jet outlets may have diameters ranging from approximately 4 mm to 8 mm, though the optimal diameter depends on several factors including maximum intended operating pressure, sensitivity of target tissue, and desired cleaning or stimulation intensity.

The key insight is that increasing jet diameter increases the contact area on skin approximately with the square of the diameter, thereby distributing force over a much larger area and reducing force per unit area to comfortable levels. This is counterintuitive because one might assume that smaller, more focused jets would be more effective. However, the inventor has discovered that larger diameter jets, while distributing force over a larger area, provide equivalent or superior cleaning and stimulation effectiveness because: (1) they can operate at higher pressures without causing pain; (2) they deliver greater total water volume; (3) they provide broader coverage area requiring less precision in positioning; and (4) the water stream remains coherent over greater distance from the jet outlet.

In embodiments intended for genital stimulation, larger jet diameters are particularly important because stimulation may involve sustained exposure at higher pressures than typically used for cleaning. The larger diameter enables users to adjust pressure to their desired intensity level without risking pain or tissue damage.

In embodiments intended for animal washing, the jet diameter specifications become even more critical because animal skin varies significantly in sensitivity between species and body areas. Cats and small dogs, for example, have much thinner skin than humans in many body regions. The larger jet diameters enable safe operation across a wide range of animal sizes and skin sensitivities.

It should be understood that the specific optimal jet diameter may vary based on individual user sensitivity, intended use (cleaning vs. stimulation vs. animal washing), target body area, and available water pressure. However, the principle remains constant: jet diameters must be sufficiently large to distribute pressure over adequate surface area to avoid pain while delivering effective performance.

The jet system employs precision-engineered holes that control both the direction and dispersion of water flow. The holes are sized and angled to create optimal water stream patterns while maintaining sufficient pressure for effective cleaning through the water pressure control mechanism. In one embodiment, the water pressure control system works in concert with the precisely angled jets to deliver controlled streams that provide thorough coverage while preventing unwanted spray or splash beyond the intended cleaning areas.

The strategic positioning and angling of these supplementary jets enables effective hair washing capabilities while maintaining the core functionality of intimate area cleaning. This dual-purpose design addresses multiple hygiene needs through a single integrated system, particularly beneficial for users with physical limitations or those requiring assistance with bathing tasks.

In a preferred embodiment, the water jets may be arranged in a pattern within the seat structure to provide comprehensive coverage of intimate areas requiring cleaning. The jet system can incorporate multiple outlet points positioned at specific angles to direct water flow for optimal cleaning effectiveness. In one embodiment, the jets are configured to deliver water streams through carefully engineered holes in the seat surface, with some jets specifically oriented to facilitate hair washing capabilities for female users. The jet outlets may be integrated flush with the seat surface to maintain user comfort while ensuring proper water flow direction for thorough cleaning. The arrangement and positioning of the jets enable effective cleansing while the user maintains a stable, seated position, reducing the risk of falls or injuries associated with traditional bathing methods.

An embodiment of the invention provides a bottom-up washing configuration that enables users to clean the lower portions of the body, including the genital, buttocks, and inner thigh areas, without exposure to overhead water delivery and without requiring the user to stand. This configuration is particularly beneficial for female users who wish to wash lower body areas without wetting hair or facial areas; for individuals with psychological conditions affecting tolerance of facial, head, or overhead contact with water; for post-surgical patients who require lower body cleaning without the physical exertion of standing in a conventional shower; and for individuals who, for any reason, require or prefer a seated bathing position. The bottom-up washing configuration delivers water upward from the device's jet array, providing effective lower body cleaning while the user's upper body, hair, and face remain dry. This bottom-up delivery principle represents a fundamental design departure from conventional top-down showering and constitutes a distinct and novel washing modality that does not exist in prior art chair-mounted bathing devices.

In a preferred embodiment, the device incorporates a plurality of attachment points strategically positioned to enable secure mounting to various support structures. These attachment points are integrated into the device's structure to facilitate stable connection to chairs, wheelchairs, toilets, hospital beds, and conventional beds.

In a preferred embodiment, the device includes attachment points specifically configured to interface with a corresponding chair designed for use with the bathing device, and in an optional system embodiment that is provided with the device. These attachment points may comprise receiving brackets or slots integrated into the chair's structure that align precisely with corresponding mounting points on the device. The attachment system enables secure mounting while maintaining proper positioning of the water jets and other functional components relative to the user's seated position. In one embodiment, the attachment points interface with waterproof materials of the corresponding chair to create a stable, sealed connection that prevents water intrusion while enabling proper water flow and drainage during operation of the bathing device. The integrated design of the chair and device attachment points ensures optimal alignment of the water distribution system and control mechanisms while maintaining user comfort and safety during operation.

In one embodiment, the attachment points may include adjustable mounting brackets, clamps, or fasteners that enable secure installation while accommodating different surface configurations and dimensions of the various support structures. The attachment system is designed to maintain stability during operation while allowing the device to be removed or transferred between different mounting locations as needed.

The plurality of attachment points works in coordination with the device's overall structure to ensure proper positioning of the water jets and other functional components relative to the user. In a preferred embodiment, the attachment system enables the device to be securely mounted while maintaining proper alignment of the water distribution system and control mechanisms.

The attachment points are configured to provide stable mounting that can withstand the forces generated during operation of the water jets while maintaining user safety and comfort. The system's versatility in attachment options enables the device to be effectively utilized across various care environments, from private homes to healthcare facilities.

In a preferred embodiment, the device incorporates an adaptable attachment system that enables secure mounting to multiple types of support structures commonly found in both home and healthcare environments.

For chair attachment, the device includes adjustable mounting points that can secure to standard chair frames while maintaining proper positioning of the water jets and control mechanisms. The attachment system accommodates various chair designs through adaptable brackets and fasteners that create stable connections to chair supports.

In the wheelchair configuration, the embodiment features specialized attachment points designed to interface with common wheelchair frame components. These attachments enable secure mounting while maintaining accessibility to wheelchair functions and ensuring proper positioning of the device's cleaning systems relative to the seated user.

For toilet mounting, the preferred embodiment incorporates attachment points configured to secure the device to standard toilet fixtures. The mounting system maintains stability during operation while enabling proper alignment of the water distribution and jet systems for effective cleaning.

In hospital bed applications, the device's attachment system is designed to interface with standard hospital bed frames and rails. The mounting points accommodate the specialized requirements of medical environments while ensuring secure positioning of the device for bedridden users.

For conventional bed mounting, the preferred embodiment includes adaptable attachment points that can secure to standard bed frames or headboards. These attachments enable stable mounting while maintaining proper positioning of the device's functional components for effective operation.

In some embodiments, the device includes an integrated attachment system comprising strategically positioned strap holes and mounting points across the seat structure. The water channel pipes (107) and associated support structures incorporate bar structures that provides both structural weight support and houses the internal water distribution channels. The device in an embodiment features lateral strap slots for strap placement, along with two additional front and back strap slots, enabling secure mounting to various chair configurations.

The device in an embodiment features lateral strap slots for strap placement, along with two additional front and back strap slots for secure mounting. Each strap hole is reinforced to maintain structural integrity during repeated use and accommodate standard-width securing straps. The strap holes positioned on the lateral aspect are located where the water inlet was previously positioned in earlier designs. The front-to-back strap hole sets enable the device to be securely fastened to the front and back legs of a chair, while the side-to-side set provides lateral stability by securing to the chair's side supports.

The attachment system in an embodiment is designed to accommodate various chair configurations, including but not limited to standard four-legged chairs, wheelchairs, and shower chairs. Additional support structures have been integrated to enhance weight-bearing capacity. The spacing between strap holes is engineered to allow for adjustment based on different chair dimensions and designs.

In addition to the strap hole system, the device in an embodiment includes mounting points along its sides designed to accommodate suction cup attachments. These suction cup mounting points enable secure attachment to smooth, non-porous surfaces such as built-in shower benches.

The straps, when threaded through the designated holes, create a secure under-chair mounting configuration that maintains the device's stability during use while allowing for easy installation and removal. This versatile attachment system enables the device to be readily transferred between different seating surfaces as needed.

In exemplary embodiments designed as toilet/commode applications, the device seats directly over standard toilet seats, with waste and water draining through the diamond hole pattern (103) directly into the toilet bowl. The lateral water streams (400) provide cleaning without requiring complex internal plumbing, while the attachment system secures the device to standard toilet configurations.

Across all mounting configurations, in a preferred embodiment the attachment system works in coordination with the device's water distribution system, ensuring proper alignment of water jets, maintenance of stable water pressure, and optionally when a soap dispenser is included, effective soap dispensing, regardless of the mounting surface.

In an embodiment, the water flow system comprising water jets maintains consistent functionality regardless of mounting configuration through an integrated network of water channels that connect the shower hose inlet to the strategically positioned jets. The water channel pipes (107) and associated support structures incorporate bar structures that provide both structural weight support and house the internal water distribution channels through which water travels. When water enters inlet 106, it automatically pushes both ways through the bar structures, traveling left and right to supply the jet system. The water distribution system directs flow from the pressure control mechanism through these internal channels to each jet outlet, maintaining specific angles and pressure regardless of the device's mounting position.

In an embodiment, the device is configured for placement on built-in shower seats and sitting ledges integrated into shower compartments, enabling users who shower in a seated position to achieve intimate area cleaning through the device's jet system while benefiting from the enclosed shower environment for water containment and drainage. The device may be positioned on a shower bench, fold-down shower seat, or integral shower ledge, and connected to the shower supply line through a standard shower hose connection, requiring no permanent installation or modification to the shower fixture.

In an embodiment, the device body is manufactured from materials configured for permanent or semi-permanent installation within shower compartments or bathing enclosures, including porcelain, ceramic tile, natural stone such as marble or granite, engineered stone, or composite materials designed to match the aesthetic and material specifications of the surrounding shower fixture. These installation-grade embodiments may be integrated into shower infrastructure during construction or renovation, providing a permanently installed intimate area washing station as a built-in shower fixture. The permanent installation embodiments retain all functional characteristics of the portable device, including the upward-facing jet array, aggregate drainage capacity exceeding water supply volume, and optional modular compartment architecture, while providing the aesthetic integration and structural permanence of a fixture installation.

At the heart of the present invention in an embodiment is the inventor's discovery of a critical functional relationship between upward-facing water jets and drainage system volume capacity. The inventor has recognized that for water jets configured to spray upward against gravity toward intimate areas of a seated user, a corresponding drainage system with adequate volume capacity is essential to maintain jet spray pressure and effectiveness.

When a user is seated on the device, the user's body weight and positioning create a partial enclosure that traps water discharged from the upward-facing jets. This water, under the influence of gravity, falls back onto the device's superior (upper) surface. Without adequate drainage, this returning water accumulates and pools on the surface, creating a layer of standing water. This pooled water has two detrimental effects. First, it adds weight to the superior aspect of the device, creating back-pressure that opposes the upward water flow from the jets. Second, the pooled water submerges or partially submerges the jet outlets, disrupting the coherent water streams and dissipating their force.

The present invention solves this problem through a specific design relationship: the drainage openings (103) are configured with collective volume capacity sufficient to evacuate water at a rate equal to or exceeding the water output rate of the upward-facing water jets. This ensures continuous water evacuation, preventing accumulation that would inhibit jet spray pressure. The paired relationship between upward spray capability and drainage volume capacity is what enables the jets to maintain their ability to shoot water upward with force throughout operation.

In accordance with a preferred embodiment, the aggregate drainage capacity of the drainage apertures (103) exceeds the total volumetric flow rate of the water jets during operation. This drainage-volume-exceeds-supply principle is a critical functional requirement of the present invention, ensuring that the upward-facing water jets maintain their designed pressure and spray characteristics throughout operation regardless of user positioning or duration of use. The central drainage area defined by the diamond-pattern drainage holes (103) extends to a height of approximately nine inches, providing substantial drainage surface area. The central drainage area incorporates a tilt angle configured so that water contacting the drainage surface flows by gravity toward the drainage apertures rather than pooling on the surface. Additionally, the lateral areas housing the side jet compartments each incorporate a corresponding tilt angle configured to direct water outward and away from the device through the drainage system. The combination of the central area tilt and the lateral area tilts operates in concert with the drainage capacity excess principle to ensure that all water delivered by the jets is continuously and completely evacuated during operation, maintaining jet spray pressure and preventing any accumulation of standing water on the device surface. Without this engineered excess of drainage capacity over supply volume, pooled water would add weight to the upper surface and submerge jet outlets, dissipating the coherent water streams essential for effective cleaning and stimulation.

In accordance with embodiments, without this drainage system with adequate volume capacity, the pooled water would otherwise weigh down or impede the upward facing water jets limiting the pressure and associated effectiveness. In accordance with an embodiment, there must be a combination of pressure and corresponding drainage to allow the water to shoot upward at force. The drainage holes positioned at the top portions of the device in accordance with an embodiment contribute to this drainage function, facilitating water flow away from the central areas rather than requiring all drainage to occur through only the lowest points.

This upward-spray-and-drainage pairing represents a departure from prior art bathing devices that may have jets positioned to spray at various angles or may have drainage holes for general water evacuation, but do not teach the specific relationship wherein drainage volume capacity must equal or exceed jet output volume to enable sustained upward-against-gravity water delivery. This relationship is particularly important in applications involving intimate cleaning, intimate stimulation, and animal washing, where the user or animal is positioned directly over the jets, creating the water-trapping effect that necessitates the coordinated drainage capacity.

The present invention in embodiments further distinguishes from prior art bathing devices in several additional respects. First, prior art does not teach a snap-in modular compartment architecture with interchangeable functional modules that enable a user to reconfigure the device for different functions—such as water jetting, soap dispensing, secondary shower head attachment, or pressure blanking—without tools. Second, prior art does not teach a pressure-actuated sealing mechanism wherein a user's body weight upon the device creates a seal within internal fluid conduits, the seal being formed by a rigid internal tube having an outer diameter of approximately three-eighths of an inch that engages with a corresponding valve seat when the user sits upon the device. Third, prior art does not teach the combination of tilted drainage surfaces—both within the central drainage area and within the lateral jet compartment areas—configured to direct water toward drainage apertures, in conjunction with a drainage capacity that exceeds the total volumetric flow rate of the water supply jets, to ensure continuous and complete water evacuation during operation. These additional distinctions, individually and in combination with the drainage-volume-exceeds-supply principle described above, define a bathing device that is fundamentally different in architecture and function from any prior art bathing apparatus.

The water flow jets in an exemplary embodiment are engineered with precisely angled holes built within the seat structure to create optimal water flow patterns for intimate area cleaning. As used in this specification and claims in accordance with various embodiments, “diamond-pattern water supply and drainage system” or “diamond-pattern water supply jets and drainage holes” refers to the arrangement of water supply jets and drainage openings distributed across the seat surface in a diamond or rhombus-shaped pattern that integrates both water delivery functionality and water evacuation functionality in a coordinated configuration.

The water distribution system incorporates internal channel design where water enters inlet (106) and automatically pushes both ways through the bar structures that form the strap attachment points (104) and straps (105). These bars serve a dual function, providing structural weight support while simultaneously functioning as the internal water pipe system through which water travels to supply jets throughout the unit. The water flows left and right through the channels, with the entire lateral functioning as both a channel and jet system in accordance with an embodiment. The channel is created as a thin space at different thicknesses through a molding manufacturing process. At the location where the diamond pattern is positioned, the elevation drops down approximately ¾ inches, creating a small air cavity where water fills and pressurizes.

A critical aspect of this system is the sequential filling characteristic. The system is designed so that water flows through the outside jets first, then fills the diamond drainage holes last, optimizing water pressure and distribution throughout the device. This sequential filling prevents premature drainage that would reduce jet pressure before adequate water delivery is achieved.

Water pressure through these jets in accordance with an embodiment is controlled by the ergonomic half-moon shaped dial, allowing users to adjust flow intensity according to personal preference and comfort levels. The water distribution system maintains consistent functionality across various mounting configurations, ensuring reliable performance whether attached to chairs, wheelchairs, or specialized water resistant or waterproof bed overlays.

The water pressure optimization in accordance with an embodiment is accomplished through a series of design considerations minimizing the volume of open space inside the water supply channel system and reservoir. The water supply pressure in an exemplary embodiment averages 2 GPM and fills the water capacity volume within 5 seconds after opening the water supply valve. The efficient geometry of this configuration optimizes the water pressure available from residential or commercial bathroom/shower water sources.

The jet configuration includes multiple arrays of openings positioned at calculated angles to ensure thorough coverage of intimate areas while maintaining user comfort, which in some examples is intended to be delivered to provide genital stimulation, particularly for users otherwise unable to perform genital stimulation activities due to physical limitations. Water pressure through these jets is controlled by the ergonomic half-moon shaped dial, allowing users to adjust stimulation intensity according to personal preference and comfort levels. The water distribution system maintains consistent functionality across various mounting configurations, ensuring reliable performance whether attached to chairs, wheelchairs, or specialized rubber bed overlays. The precise engineering of jet angles and water flow patterns accommodates different user positions and physical requirements while delivering effective stimulation for intimate personal care needs.

In an embodiment addressing intimate wellness needs, the device provides therapeutic sensory stimulation to intimate areas for users with physical limitations. Sexual wellness and intimate satisfaction are important aspects of quality of life and psychological health. In association with exemplary uses, individuals who lose the ability to manually stimulate themselves due to disability—including paralysis, arthritis, loss of manual dexterity, or limited mobility—experience not only the loss of physical pleasure but also a loss of autonomy and control over an intimate aspect of their lives. This can contribute to depression, reduced self-esteem, and diminished life satisfaction.

The present device in an exemplary embodiment addresses this need by providing a means for independent intimate stimulation that does not require manual manipulation. The user positions themselves on the device in a comfortable seated position and operates the water pressure control mechanism (107) to achieve desired stimulation intensity. The water jets (110) directed toward genital areas provide pressurized water streams that deliver pleasurable sensory stimulation. The physical sensation is similar to manual stimulation but is delivered through water pressure rather than touch, enabling users without functional use of their hands to experience these sensations independently.

A critical feature in this embodiment is the selective jet activation capability. In an exemplary embodiment, the device includes valves or other shutoff means that enable individual jets or groups of jets to be selectively deactivated. Outer jets (101) positioned laterally can be shut off while central jets (110) directed toward genital areas remain active. This selective deactivation redirects water flow and pressure—when fewer jets are active, available water pressure is concentrated through the remaining active jets, increasing their output intensity. By shutting off outer jets, pressure is concentrated in the central genital area jets, providing more intense stimulation where desired.

For female users, central jets (110) may be specifically positioned and angled to direct water streams toward the vaginal opening, clitoral area, and surrounding vulvar tissue. The positioning may be adjustable to accommodate anatomical variation. For male users, jets may be positioned to direct water toward the penis, glans, and testicular area. The adjustable pressure enables users to achieve desired stimulation intensity, from gentle sensation to more vigorous stimulation.

The water pressure control mechanism (107) is particularly important in this embodiment. The half-moon ergonomic dial design enables users with arthritis, limited grip strength, or hand tremors to make fine adjustments to stimulation intensity. The mechanism provides continuous pressure adjustment through a wide range, enabling users to slowly increase intensity as desired or to rapidly reduce intensity if stimulation becomes too intense.

The water jet outlet diameters are specifically configured in this embodiment to enable operation at pressures sufficient for effective stimulation without causing pain. As described in detail below, larger diameter jets distribute pressure over larger surface areas, enabling higher pressures to be used comfortably. This is particularly important for stimulation applications where sustained exposure at higher pressures may be desired.

The drainage system (103) plays an important role in this embodiment. During sustained use for stimulation purposes, significant water volume is delivered. Without adequate drainage, water would pool on the device surface, submerging jets and reducing their effectiveness. The diamond-pattern drainage holes with volume capacity equal to or exceeding jet output ensure that water is continuously evacuated, maintaining jet effectiveness throughout use.

Privacy considerations are addressed in an example through the device's innocuous appearance and multi-purpose functionality. The device appears to be, and functions as, a legitimate medical/hygiene device for individuals with physical limitations. Its additional capability for intimate stimulation is not apparent from external appearance and can be utilized discreetly.

It should be understood that this intimate wellness functionality addresses a legitimate therapeutic need for individuals with disabilities. The ability to independently experience intimate pleasure contributes to psychological health, self-esteem, sense of autonomy, and overall quality of life. This embodiment provides a solution that respects user dignity and privacy while addressing needs that are otherwise unmet in the disabled population.

The device may be used solely for stimulation purposes, or stimulation may be combined with hygienic cleaning in a single use session. The same features that enable effective intimate area cleaning—strategic jet positioning, adjustable pressure, adequate drainage, pain-preventing jet diameters—also enable effective intimate stimulation. This dual functionality provides users with a single device that addresses multiple needs.

In certain embodiments, the water delivery system may provide pulsating or varying water pressure rather than constant pressure. This can be achieved through valves that open and close cyclically, or through pressure regulators that vary output. Pulsating stimulation provides different sensory effects than constant pressure and may be preferred by some users. The water jet configuration and pressure settings may be optimized to provide stimulation sufficient to achieve orgasmic response in users who cannot manually stimulate themselves due to physical limitations.

In an embodiment adapted for washing companion animals, the device addresses the challenge associated with cleaning animals, including challenges faced by individuals with physical limitations who are unable to adequately bathe their pets using traditional methods. Many pet owners with disabilities such as arthritis, limited mobility, or reduced strength find it impossible to physically restrain and manually wash their animals, particularly when the animals themselves have physical limitations requiring gentle handling. The device in accordance with such embodiment addresses such needs.

The platform or seat structure (100) in accordance with such embodiment serves as a washing surface upon which the animal is positioned. The surface may be textured or provided with raised edges to help prevent the animal from slipping or moving excessively during washing. The drainage holes (103) are particularly important in this embodiment as they evacuate not only water but also pet hair, dander, and other debris loosened during washing.

The water jets (101, 110) are positioned to deliver water streams that clean the ventral (underside), lateral (side), and dorsal (back) aspects of the animal's body. The adjustable water pressure control mechanism (107) is critical in this exemplary application because animals of different sizes and species have vastly different tolerances. A small cat, for example, requires much gentler water pressure than a medium-sized dog. Additionally, animals with thin or sensitive skin, or those recovering from injury or surgery, require carefully controlled lower pressures. The device addresses an acute need in caring for elderly or disabled animals who cannot stand steadily in a traditional bath. From the caregiver's perspective, the device transforms animal bathing from a physically demanding task into a manageable one. A caregiver with arthritis need not grip and manipulate the wet animal or bend over a bathtub. The caregiver can remain seated, operating the simple pressure control mechanism while the water jets perform the washing. This embodiment demonstrates the versatility of the underlying inventive concept—providing effective care through strategically positioned water jets while enabling users with physical limitations to perform care tasks independently.

The water distribution system incorporates a manifold design that maintains equal pressure and flow rates to all jets regardless of the device's orientation when mounted to different support structures. This ensures that whether the device is attached to a chair, wheelchair, toilet, hospital bed, or conventional bed, the water jets maintain their designed flow patterns and cleaning effectiveness.

In a preferred embodiment, the jet system's holes are engineered at specific angles to create optimal cleaning coverage while minimizing splashing or overspray. The integration of the soap control system in an alternative embodiment with the water distribution network enables proper mixing and delivery of cleaning solution through the angled jets, maintaining consistent performance across all mounting configurations.

In accordance with an embodiment, the system comprises a diamond-pattern drainage system (103) that provides multiple exit points distributed across the seat surface, enabling rapid water evacuation without the standing water issues associated with conventional drainage approaches. In applications requiring enhanced drainage, the system accommodates vacuum-assisted water removal as one skilled in the art would appreciate functions similar to marine sanitation systems in an example, providing active water extraction for healthcare environments.

The water flow system works in coordination with the device's attachment points to ensure proper alignment of the jet outlets relative to the user regardless of mounting surface. This maintains the effectiveness of the specifically angled water streams for both intimate area cleaning and hair washing capabilities across all installation scenarios.

In a preferred embodiment, the device enables effective cleaning of intimate areas while the user maintains a stable seated position, addressing the challenges faced by individuals with physical limitations or those requiring assistance. The strategic positioning of water jets within the seat structure enables targeted cleaning of both the genital and buttocks areas through precisely angled water streams. In embodiments where a soap dispensing mechanism is included, the water pressure control mechanism and soap dispensing system work in concert to deliver an adjustable mixture of water and cleaning solution directly to these intimate areas while the user remains comfortably and safely seated.

In one embodiment, the device eliminates the need for manual cleaning or potentially hazardous bathing methods by providing automated cleansing capabilities through its integrated jet system. The arrangement of jets creates intersecting water streams that provide comprehensive coverage of intimate areas requiring cleaning, while the user maintains a stable seated position on the device regardless of its mounting configuration.

The preferred embodiment enables thorough cleaning of intimate areas without requiring the user to stand or transfer to a bathtub or shower, thereby reducing the risk of slip and fall injuries that are common with traditional bathing methods. The combination of precisely controlled water pressure and strategically positioned jets ensures effective cleansing while maintaining user dignity and comfort throughout the cleaning process.

In a preferred embodiment, the device incorporates specialized water jet technology that provides comprehensive body cleaning capabilities while the user remains in a seated position. The lateral water streams positioned outside the leg areas are configured to project water in upward arcing trajectories, which in varying exemplary embodiments project water over the user's legs but below chin level, angled to land on the opposite shoulder. This configuration enables full body wash coverage including washing the opposite side of the back and opposite side of the chest, extending the device's functionality beyond intimate area cleaning to provide whole body hygiene capabilities. These specialized jets work in coordination with the water pressure control mechanism in an embodiment to deliver water at varying appropriate angles and pressure levels. The integration of whole body washing functionality with the intimate area cleaning system in accordance with embodiments of the invention provides a hygiene solution through the same water distribution network and pressure control system while maintaining the stability and safety benefits of a user being seated position as depicted by FIG. 7 or in a lying position as depicted by FIG. 8.

In accordance with various embodiments, the device's design allows for various modifications and refinements to optimize functionality while maintaining the core purpose and operation. The specifications may be adjusted to accommodate different manufacturing processes, materials, or technological improvements that enhance the device's performance. For example, the water jet configuration in an embodiment could be modified to include additional angles or outlet positions while maintaining the fundamental cleaning capabilities. The integrated soap dispensing system in an alternative embodiment may be refined to incorporate different reservoir capacities or dispensing mechanisms based on usage requirements. The attachment system in an embodiment could be adapted to include various mounting configurations beyond the initial design while preserving secure connection to support structures. Additionally, the water pressure control mechanism in an embodiment may be enhanced with different adjustment ranges or control interfaces to improve user experience. These potential modifications maintain the device's essential function as a chair-attachable bathing device while allowing for technological advancement and optimization of the design.

In an embodiment, the device optionally incorporates an integrated water pressure control mechanism that enables adjustment of water flow intensity through the jet system. In alternative embodiments, water pressure may be regulated through an external water pressure regulator connected between the external water source and the water inlet, which is commercially available as a standard plumbing accessory and may be used in conjunction with the device without requiring the device to incorporate internal pressure regulation components.

In accordance with additional embodiments, the device may be constructed from materials suitable for permanent or semi-permanent installation within shower compartments or bathing enclosures. Such permanent installation variants may comprise porcelain, tile, stone, composite, or other durable materials configured to be integrated into the built environment. In these embodiments, the device is fixed in position within the shower compartment rather than being removably attached to furniture, while maintaining the same functional water jet positioning, drainage capacity relationship, and water distribution system described herein. The permanent installation embodiments enable the device to serve as a built-in fixture providing the same seated bathing, cleaning, and therapeutic capabilities in a finished architectural installation.

In accordance with further embodiments, the device is configured for compatibility with built-in shower seats and sitting ledges commonly found in accessible shower installations. The device may be positioned upon or secured to existing shower bench surfaces, integrated shower seats, or built-in sitting ledges to provide the water jet cleaning and drainage functionality described herein without requiring a separate chair or furniture piece. The attachment system accommodates the dimensions and configurations of standard shower seats and ledges, enabling users who already have accessible shower seating to augment their existing installation with the water delivery and drainage capabilities of the present invention.

In accordance with an embodiment, the device operates as a bottom-up washing system that enables thorough cleaning of lower body areas including genital and buttocks regions without wetting the user's hair or face. The upward-facing water jets direct pressurized water streams from below the seated user, providing comprehensive lower body hygiene while leaving the upper body, head, and hair dry. This bottom-up washing configuration is particularly beneficial for users who wish to perform lower body cleaning without the inconvenience of wetting and re-styling hair, and for users with psychological or sensory conditions that cause distress when water contacts the face or head. The bottom-up approach enables targeted cleaning sessions that address intimate hygiene needs independently from full-body or hair washing routines.

In summary, the preferred embodiment provides an innovative bathing solution that addresses the long-standing challenges faced by individuals with physical limitations, those recovering from surgery, and others requiring assistance with personal hygiene. Through its integrated system of water jets and pressure controls, the device enables effective cleaning of intimate areas while maintaining user dignity and safety in a seated or lying position.

The device's versatile attachment system in embodiments allows for secure mounting to various support structures, from chairs and wheelchairs (powered or manual) to hospital beds and toilets, making it adaptable to different care environments. The strategic positioning of water jets and precise control mechanisms ensures consistent performance across all mounting configurations while minimizing splashing and maintaining user comfort.

The various embodiments described herein—hygienic cleaning, animal washing, and intimate wellness—share common underlying innovations that distinguish this invention from prior art bathing devices. First, the paired upward-facing water jets and drainage volume capacity relationship ensures that water can spray upward against gravity with sustained force. The drainage openings are configured with collective volume capacity equal to or exceeding the water output rate of the jets, preventing water accumulation that would otherwise pool on the device surface and inhibit jet spray pressure. Second, the water jet outlet diameters are specifically sized to distribute water pressure over sufficient skin surface area to provide effective cleaning or stimulation force without causing pain, even at higher pressures. Third, the diamond-pattern water supply and drainage system integrates both water delivery jets and drainage openings in a coordinated configuration, with sequential filling characteristics that optimize pressure distribution. Fourth, the selective jet activation capability enables users to deactivate outer jets while maintaining central jets, concentrating water pressure where desired for either enhanced cleaning or pleasurable stimulation. These common elements enable a single device design to address hygiene, therapeutic, animal care, and intimate wellness needs of users with physical limitations, maximizing the device's utility and value while maintaining manufacturing efficiency.

While preferred embodiments of the present invention have been shown and described herein, it will be obvious to those skilled in the art that such embodiments are provided by way of example only. It is not intended that the invention be limited by the specific examples provided within the specification. The various embodiments described—hygienic cleaning for users with physical limitations, animal washing for companion animals with disabilities or requiring assistance, and intimate stimulation enabling users with physical limitations to experience pleasurable sensations independently—share common underlying innovations: strategic positioning of water jets with outlet diameters sized to prevent pain; adjustable pressure control accessible to users with limited mobility; drainage systems that prevent water accumulation; and the critical relationship between upward-facing jets and drainage volume capacity. These common elements enable a single device design to address multiple needs while maintaining manufacturing efficiency. Numerous variations, changes, and substitutions will now occur to those skilled in the art without departing from the invention. It is therefore contemplated that the invention shall cover all such alternatives, modifications, variations or equivalents. It is intended that the following claims define the scope of the invention and that methods and structures within the scope of these claims and their equivalents be covered thereby.

I claim:

1. A bathing device comprising:
a device body defining an upper surface configured to support a user and a lower surface;
a water inlet configured to receive pressurized water from an external water source;
an internal water distribution system within the device body configured to distribute water from the water inlet to a plurality of water delivery points;
a plurality of upward-facing water jets positioned within the device body and configured to direct pressurized water flow upward against gravity toward a user positioned on the upper surface;
a plurality of drainage apertures integrated into the device body and configured to evacuate water from the upper surface during operation;
at least one attachment mechanism configured to secure the device body to a support structure; and
wherein an aggregate drainage capacity of the plurality of drainage apertures is sufficient to evacuate water at a rate at least equal to a total volumetric flow rate of the plurality of upward-facing water jets during operation, thereby ensuring continuous water evacuation and preventing water accumulation on the upper surface that would inhibit jet spray pressure.

2. The device of claim 1, wherein the upper surface comprises a central drainage area having a first tilt angle and one or more lateral areas each having a second tilt angle, the first tilt angle and the second tilt angle each configured to direct water by gravity toward the plurality of drainage apertures.

3. The device of claim 2, wherein the central drainage area extends to a height of approximately nine inches.

4. The device of claim 1, wherein the device body defines a closed main body having a plurality of compartment receptacles, the device further comprising a plurality of modular compartments each configured to be removably received within a corresponding compartment receptacle through a snap-fit engagement without requiring tools, each modular compartment establishing fluid communication with the internal water distribution system upon insertion.

5. The device of claim 4, wherein the plurality of modular compartments comprises at least two of: a standard water jet compartment housing one or more upward-facing water jets; a cleaning solution reservoir compartment configured to store and dispense a cleaning solution; a secondary shower head attachment compartment comprising a nozzle having a diameter of approximately one-half inch; and a pressure-redirecting blanking module configured to block water flow to the corresponding compartment receptacle.

6. The device of claim 4, wherein removal of one or more lateral modular compartments from the device body redirects available water pressure to remaining active compartments, thereby concentrating water pressure at one or more central jets directed toward genital areas of the user.

7. The device of claim 1, wherein each of the plurality of upward-facing water jets has an outlet opening with a diameter of at least four millimeters, configured to distribute water pressure over sufficient skin surface area to provide effective water delivery without causing pain to tissue contacted by water streams from the jets.

8. The device of claim 1, wherein the plurality of upward-facing water jets and the plurality of drainage apertures are arranged in a diamond or rhombus-shaped pattern across the upper surface of the device body.

9. The device of claim 1, further comprising a plurality of lateral water jets positioned adjacent to a seated user's legs and configured to project water streams in arcing trajectories toward the user's torso at heights of between twenty-four and thirty-six inches.

10. The device of claim 1, wherein the at least one attachment mechanism is configured to secure the device body to at least one of: a hospital bed in conjunction with a waterproof bed overlay positioned beneath the device, a built-in shower seat, or a sitting ledge.

11. The device of claim 1, wherein the device body comprises a material selected from the group consisting of porcelain, tile, stone, and composite, and is configured for permanent or semi-permanent installation within a shower compartment or bathing enclosure.

12. A method of cleaning a user while the user is positioned on a bathing device, the method comprising:
positioning the user on a bathing device having a device body with a plurality of upward-facing water jets and a plurality of drainage apertures, the bathing device secured to a support structure;
supplying pressurized water from an external water source to the plurality of upward-facing water jets through an internal water distribution system of the bathing device;
directing pressurized water from the plurality of upward-facing water jets upward against gravity toward body areas of the user; and
evacuating water through the plurality of drainage apertures at an aggregate drainage rate that exceeds a total volumetric flow rate of the plurality of upward-facing water jets, thereby preventing water accumulation on the device body and maintaining jet spray pressure throughout operation.

13. The method of claim 12, wherein directing pressurized water toward body areas of the user comprises directing water toward genital and buttocks areas of the user while the user's hair and face remain substantially unwetted by the upward-facing water jets, thereby providing a bottom-up washing configuration.

14. The method of claim 12, further comprising selectively deactivating one or more outer jets while maintaining activation of one or more central jets directed toward genital areas of the user, thereby concentrating water pressure for enhanced cleaning or therapeutic stimulation.

15. The method of claim 12, further comprising inserting one or more modular compartments into the bathing device by snap-fit engagement to configure the bathing device for a selected operational mode prior to supplying pressurized water.

16. The method of claim 12, wherein the support structure comprises at least one of: a chair, a wheelchair, a toilet, a hospital bed, a built-in shower seat, or a sitting ledge.

17. The method of claim 12, further comprising regulating water pressure supplied to the bathing device using an external water pressure regulator connected between the external water source and the bathing device.

18. A modular bathing accessory system comprising:
a main body defining an upper surface, a lower surface, an internal water distribution system, and a plurality of compartment receptacles, each compartment receptacle having a snap-fit engagement interface and at least one fluid connection port communicating with the internal water distribution system;
a plurality of interchangeable modular compartments each configured to be removably received within any of the plurality of compartment receptacles through the snap-fit engagement interface without requiring tools, each modular compartment establishing fluid communication with the internal water distribution system upon insertion;
a plurality of drainage apertures integrated into the main body;
at least one attachment mechanism configured to secure the main body to a support structure; and
wherein an aggregate drainage capacity of the plurality of drainage apertures exceeds a total volumetric flow rate of water delivered through active ones of the plurality of interchangeable modular compartments during operation.

19. The system of claim 18, wherein the plurality of interchangeable modular compartments comprises: a water jet compartment housing at least one upward-facing water jet configured to direct pressurized water toward a user; a cleaning solution reservoir compartment configured to store and dispense a cleaning solution; a secondary shower head attachment compartment comprising a nozzle configured to receive an external shower head; and a pressure-redirecting blanking module.

20. The system of claim 18, further comprising a hard plastic internal tube having an outer diameter of approximately three-eighths of an inch configured to create a pressure-actuated seal when a user is positioned on the main body, the user's weight engaging the tube with a corresponding valve seat to establish a fluid-tight seal within the internal water distribution system.

21. The system of claim 18, wherein the upper surface of the main body comprises a central drainage area and one or more lateral compartment areas, each having a tilt angle configured to direct water by gravity toward the plurality of drainage apertures.

22. The device of claim 1, wherein the device body is configured as a platform for supporting and washing a companion animal, the plurality of upward-facing water jets being configured to direct water toward ventral, lateral, and dorsal aspects of the animal, and wherein a water pressure adjustment is provided to accommodate animals of varying sizes and skin sensitivities.

23. The device of claim 1, wherein the plurality of upward-facing water jets comprises central jets positioned and angled to direct pressurized water streams toward genital areas of a seated user for therapeutic sensory stimulation, and further comprising a selective jet activation system enabling deactivation of outer jets while maintaining activation of the central jets to concentrate water pressure for enhanced intimate stimulation, whereby a user with physical limitations can independently experience pleasurable intimate sensations without requiring manual manipulation.

24. The device of claim 1, further comprising a water pressure control mechanism integrated into the device body and configured to enable adjustment of water flow intensity through the plurality of upward-facing water jets, the water pressure control mechanism comprising an ergonomic dial operable by users with limited manual dexterity.

25. The device of claim 1, wherein the water inlet comprises a one-half inch NPT threaded fitting configured for connection to a standard shower hose.
